(19) United States
(12) Patent Application Publication
(10) Pub. No.: US 2018/0328704 A1
(43) Pub. Date: Nov. 15, 2018

(54) Square Measuring Tool

(71) Applicant: Channon Kennedy, HAYWARD, CA (US)

(72) Inventor: Channon Kennedy, HAYWARD, CA (US)

(21) Appl. No.: 15/979,814

(22) Filed: May 15, 2018

Related U.S. Application Data
(60) Provisional application No. 62/506,242, filed on May 15, 2017.

(51) Int. Cl. G01B 3/10

(52) U.S. Cl. CPC G01B 3/1084; G01B 2003/1092; G01B 2003/1089

(57) ABSTRACT

A square measuring tool that combines functionalities of a tape measure and a measuring square includes a L-shaped body, a pencil holder, a lipped fence, and a distance measuring unit. The L-shaped body that functions as the measuring square includes a handle, a blade, plurality of indicators, and a plurality of numeric characters. The handle and the blade are terminally connected to each other at a right angle. The plurality of indicators and the plurality of numeric characters are graphically distributed along a top surface of the blade. The pencil holder is adjacently connected along an inner edge of the handle. The lipped fence is adjacently connected along an outer edge of the handle, opposite of the pencil holder. The distance measuring unit is operatively coupled to a top surface of the handle to measure a perpendicular distance from the blade.

The current application claims a priority to the U.S. Provisional Patent application Ser. No. 62/506,242 filed on May 15, 2017.

### FIELD OF THE INVENTION

The present invention relates generally to a measuring device. More specifically, the present is a square measuring tool that combines functionalities of a measuring square and a tape measure to simplify various carpentry works in building construction.

### BACKGROUND OF THE INVENTION

In the process of constructing a house or a building frame, proper measurement and indication of lengths is critical to the ultimate success of the project. For example, a piece of wood such as a beam or a support has to be in the proper length to maintain the structural integrity. In order to attain perfection, carpenters and various woodworkers often utilize rulers and tape measures to measure lengths and create marks before performing a cut through a given piece of wood. This system ensures that wood is cut properly the first time, resulting in minimal waste of building materials. However, such a method is not necessarily optimal. The carpenter and various woodworkers often needs to utilize several tools to accomplish what amounts to a relatively simple task of measuring beam length. For example, a user may first use a tape measure to measure the length of the beam. The user may then, while keeping the tape measure open, utilize a ruler or a measuring square to create a cutline. The cutline itself is made with a pencil or other writing implement. This whole process often requires multiple hands, which is not optimal for carpenters or woodworkers working alone. As a result, there is a greater need for a device that integrates functionalities of a measuring square and a tape measure to measure and record lines while measuring, without an excessive hassle with respect to managing a variety of measurement tools.

It is therefore an objective of the present invention to provide a square measuring tool that combines functionalities of a tape measure and a measuring square into a singular device. The present invention enables a user to measure distance with a mounted tape measure or an integrated electronic distance measuring device. Then the user can mark the lines with a pencil before starting the cutting process. Since the present invention enhances a user's ability to measure lengths and draw lines without assistance, the present invention saves time and money while providing an accurate outcome within a construction project.

### BRIEF DESCRIPTION OF THE DRAWINGS

FIG. 1 is a perspective view of the first embodiment of the present invention without the tape measure.

FIG. 2 is another perspective view of the first embodiment of the present invention without the tape measure.

FIG. 3 is a top view of the first embodiment of the present invention without the tape measure.

FIG. 4 is a side view of the first embodiment of the present invention without the tape measure.

FIG. 5 is a perspective view of the first embodiment of the present invention with the tape measure.

FIG. 6 is a perspective view of the second embodiment of the present invention with the electronic distance measuring device.

### DETAIL DESCRIPTIONS OF THE INVENTION

All illustrations of the drawings are for the purpose of describing selected versions of the present invention and are not intended to limit the scope of the present invention.

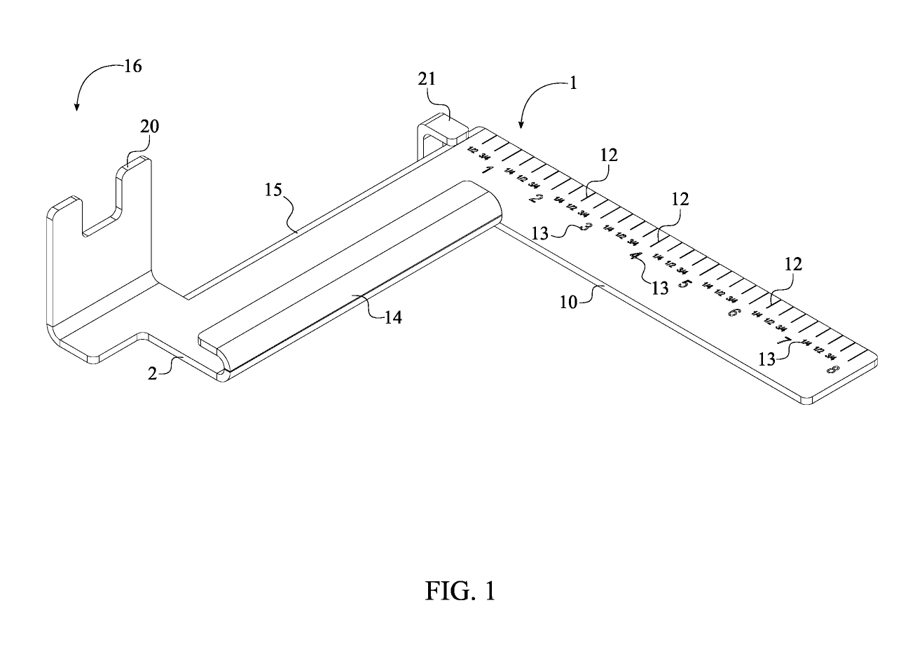

The present invention is a square measuring tool that combines the functionalities of a tape measure and a measuring square into a singular device. The present invention facilitates measurement during various carpentry works, such as stud measurements and frame measurements during house construction. The present invention comprises a L-shaped body 1, a pencil holder 14, a lipped fence 15, and a distance measuring unit 16 as shown in FIG. 1.

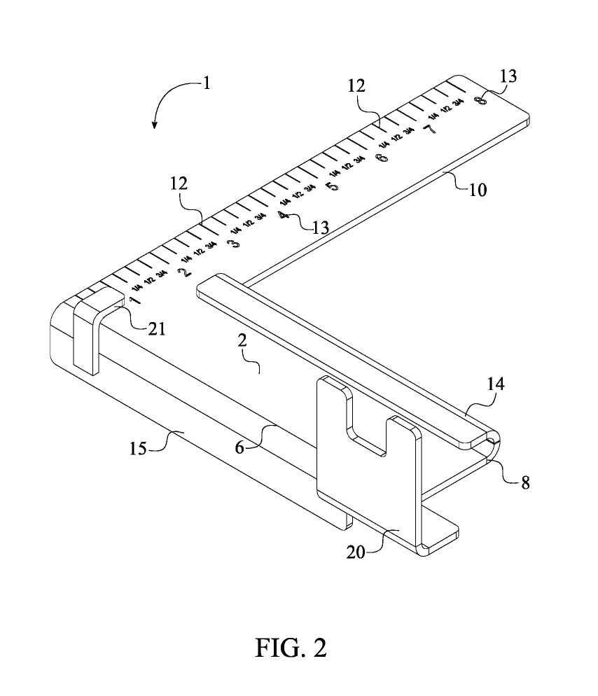

The L-shaped body 1 functions as the measuring square within the present invention and a base for the distance measuring unit 16 to be mounted. In reference to FIG. 2, the L-shaped body 1 comprises a handle 2, a blade 10, plurality of indicators 12, and a plurality of numeric characters 13. The handle 2, which is the shorter arm, provides the necessary surface area to grasp the present invention. The blade 10, which is the longer arm, provides a surface area to visually illustrate the plurality of indicators 12 and the plurality of numeric characters 13 within the present invention. The handle 2 and the blade 10 are terminally connected to each other at a right angle 11 thus representation the general shape of the measuring square. More specifically, a fixed end 3 of the handle 2 is adjacently connected to a fixed end 3 of the blade 10 so that a free end 4 of the handle 2 and a free end 4 of blade 10 can be positioned 90 degrees apart from each other.

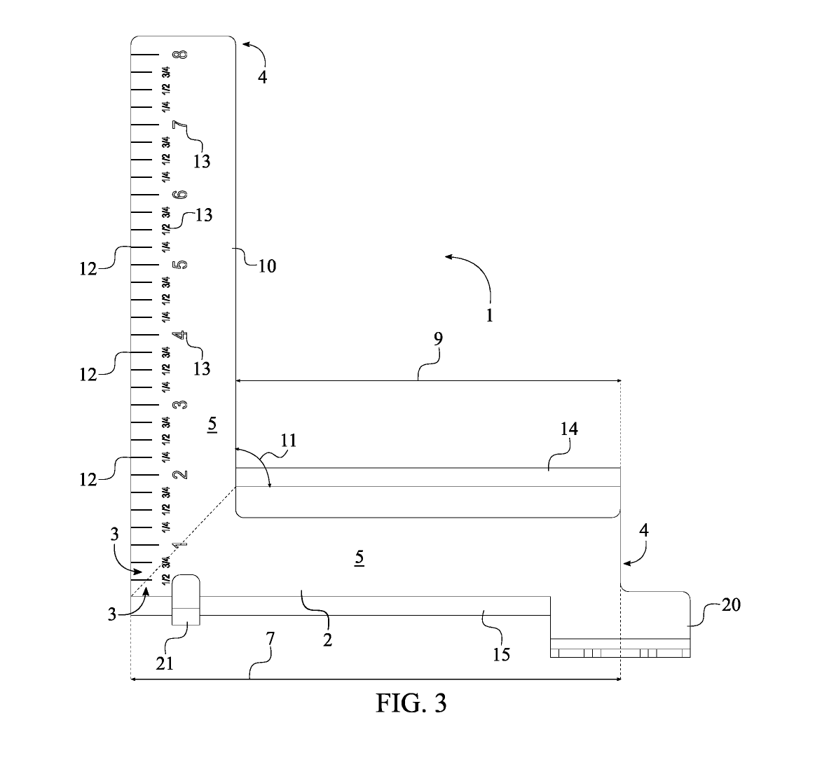

The plurality of indicators 12 and the plurality of numeric characters 13 are graphically distributed along a top surface 5 of the blade 10 as shown in FIG. 3. The plurality of indicators 12 and the plurality of numeric characters 13 collectively indicate measuring units and subdivision for the measuring unit within the present invention. More specifically, each of the plurality of indicators 12 is equally spaced apart from each other long the blade 10. Each of the plurality of numeric characters 13 is equally spaced apart from each other long the blade 10 and adjacently aligned with a corresponding indicator from the plurality of indicators 12. In other words, the plurality of indicators 12 is a linear pattern of lines running from the fixed end 3 of the blade 10 to the free end 4 of the blade 10 at a set distance from each other. The plurality of numeric characters 13 is a set of numeric characters printed relative to the plurality of indicators 12 that enables to attain comparison of distances and lengths. The set of numeric characters for the plurality of numeric characters 13 consecutively increases from the fixed end 3 of the blade 10 to the free end 4 of the blade 10. As a result, the user is able to linearly measure distance along the blade 10 with the utilization of the plurality of indicators 12 and the plurality of numeric characters 13. For example, a preferred embodiment of the present invention, the blade 10 can be graduated with inches and tenths of inches with the plurality of indicators 12 and the plurality of numeric characters 13.

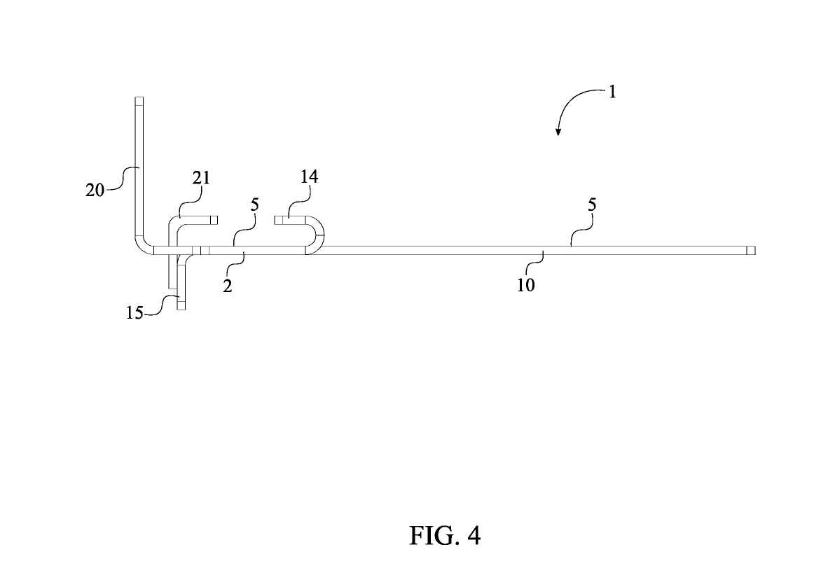

The pencil holder 14 functions as a storage casing for a pencil so that the pencil can be readily available to the user. In reference to FIG. 2 and FIG. 4, the pencil holder 14 is adjacently connected along an inner edge 8 of the handle 2 as the inner edge 8 is oppositely positioned from a heel of the L-shaped body 1. More specifically, the pencil holder 14 is extended from the fixed end 3 of the handle 2 to the free end 4 of the handle 2 and is positioned adjacent to a top surface 5 of the handle 2. In other words, the pencil holder 14 is a U-shaped channel that is oriented towards the top surface 5 of the handle 2 so that the user can easily access or store the pencil within the present invention.

The lipped fence 15 allows the user to brace the present invention flush with a piece of wood, creating a straight or an angled line that is proportionate to the wood's edge. In reference to FIG. 2 and FIG. 4, the lipped fence 15 is adjacently connected along an outer edge 6 of the handle 2 and positioned opposite of the pencil holder 14, wherein the outer edge 6 is adjacently positioned to the heel of the L-shaped body 1. More specifically, the lipped fence 15 is oriented perpendicular to the handle 2 thus delineating a right angle between the lipped fence 15 and a bottom surface of the handle 2. In other words, the lipped fence 15 is oppositely positioned to the top surface 5 of the handle 2 and oriented towards the bottom surface of the handle 2. As a result, once the bottom surface of the handle 2 is placed on a piece of wood and the lipped fence 15 is flushed with the wood's edge, the user can create the straight or the angled line. Since the pencil holder 14 is positioned adjacent to the top surface 5 of the handle 2, the user can easily access the pencil without moving or removing the present invention.

In reference to FIG. 3, a length 7 of the outer edge 6 is longer than a length 9 of the inner edge 8, wherein the difference in length enables outer profile of the L-shaped body 1. Resultantly, the outer edge 6 and the inner edge 8 are positioned coplanar about the free end 4 of the handle 2 and delineate a 45-degree angle about the fixed end 3 of the handle 2.

The distance measuring unit 16 allows the user to measure the distance between the L-shaped body 1 and a secondary reference point. In reference to FIG. 1, the distance measuring unit 16 is operatively coupled to the handle 2 so that the distance measuring unit 16 can measure a perpendicular distance from the blade 10. Depending upon different embodiment of the present invention, the distance measuring unit 16 can be an electronic tape or a manual tape.

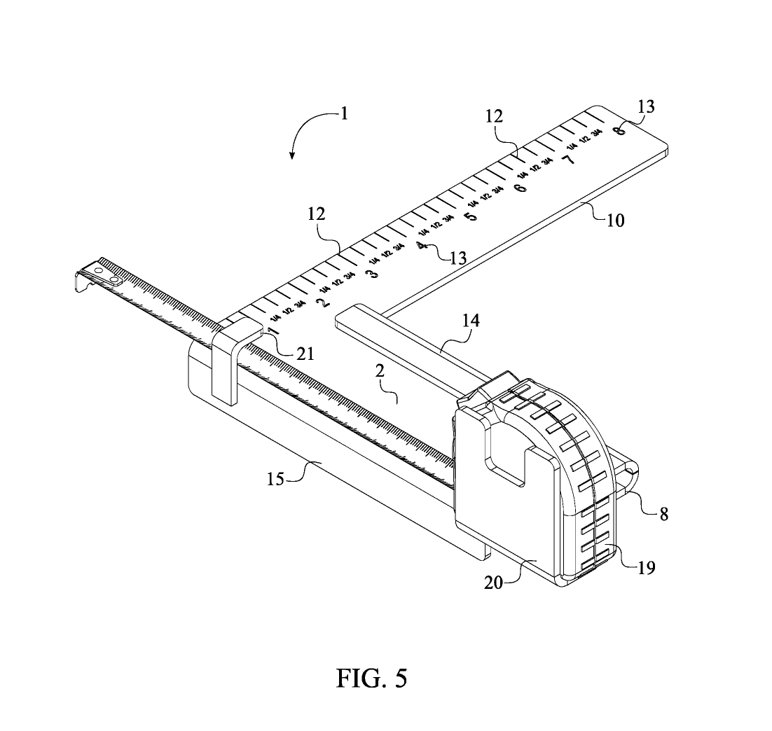

In reference to FIG. 5, a first embodiment for the distance measuring unit 16 comprises a mounting bracket 20, a tape measure 19, and a tape guide 21. The mounting bracket 20 is terminally connected to the outer edge 6 and is positioned adjacent to the free end 4 of the handle 2. The mounting bracket 20 is oriented perpendicular to the top surface 5 of the handle 2 so that the tape measure 19 can be attached to the mounting bracket 20. The present invention preferably utilizes a self-retracting measuring tape as the tape measure 19 so that a flexible tape of the tape measure 19 can be extended towards the blade 10. The tape guide 21 is terminally and externally connected to the lipped fence 15 and positioned adjacent to the fixed end 3 of the handle 2. As a result, when the flexible tape is extended from the tape measure 19, the flexible tape travels under the tape guide 21 thus maintaining a right angle between the extending flexible tape and the blade 10. In the preferred embodiment of the present invention, the tape guide 21 is a L-shaped support, wherein a long leg of the L-shaped support is terminally connected to the lipped fence 15 and a short leg of the L-shaped support is positioned offset from the top surface 5 of the handle 2. As a result, the flexible tape can be perpendicularly extended outward with the utilization of the tape guide 21.

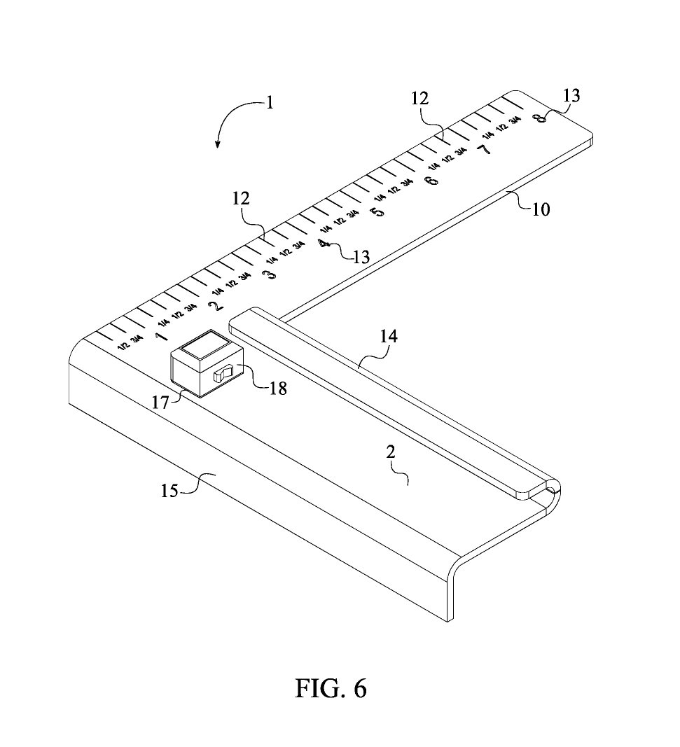

In reference to FIG. 6, a second embodiment for the distance measuring unit 16 comprises at least one fastener 17 and an electronic distance measuring device 18. More specifically, the electronic distance measuring device 18 is operatively coupled to the top surface 5 of the handle 2. The electronic distance measuring device 18 is adjacently connected to the fixed end 3 of the handle 2 by the at least one fastener 17 so that the electronic distance measuring device 18 is able to measure the distance between the present invention and the second reference point. Since the electronic distance measuring device 18 is positioned adjacent to the fixed end 3 of the handle 2, the user can grasp the second embodiment by placing their hand in between the free end 4 of the handle 2 and the electronic distance measuring device 18. Furthermore, a rangefinder of the electronic distance measuring device 18 is oriented towards the blade 10 and maintains an obstruction free path as the user's hand is placed in between the free end 4 of the handle 2 and the electronic distance measuring device 18. The rangefinder of the electronic distance measuring device 18 can emit a beam of infrared light that travels at a control rate, a beam of laser that travels at a control rate, or an electro-mechanical distance measuring sensor so that a distance between the present invention and the secondary reference point can be accurately measured. The at least one fastener 17 can be any types of fasteners, such as adhesive tapes, screws, male and female fasteners, that secure the electronic distance measuring device 18 to the handle 2. Even though the electronic distance measuring device 18 is preferably positioned atop the handle 2 within the second embodiment, the electronic distance measuring device 18 can also be internally integrated into the handle 2 within different embodiments of the present invention thus providing a continuous.

In the preferred usage of the present invention, the user first places the L-shaped body 1 against a wall or an object. The user then grasps the handle 2 and activates the distance measuring unit 16 to measure the distance perpendicular to the blade 10. If it the tape measure 19, the flexible tape is pulled against the self-retracting spring force through an opening of the tape measure 19. The user subsequently places a lip of the flexible tape atop or otherwise aligned with an object. The user observes the value displayed at the opening to determine the length of the object or area being measured. If it is the electronic distance measuring device 18, the electronic distance measuring device 18 is turned on to measure the distance. The measured distance is then displaced on a display screen of the electronic distance measuring device 18, and the user may simultaneously measure the distance perpendicular to the handle 2 using the plurality of indicators 12 and a plurality of numeric characters 13. Collectively, this arrangement enables a user to make marks on the structures being measured while measuring those structures. Upon completion, the user may release the flexible tape of the tape measure 19 or turned off the electronic distance measuring device 18. The present invention is then prepared for subsequent application.

Although the invention has been explained in relation to its preferred embodiment, it is to be understood that many other possible modifications and variations can be made without departing from the spirit and scope of the invention as hereinafter claimed.

What is claimed is:

1. A square measuring tool comprises:
a L-shaped body;
a pencil holder;
a lipped fence;
a distance measuring unit;
the L-shaped body comprises a handle, a blade, a plurality of indicators, and a plurality of numeric characters;
the handle and the blade being terminally connected to each other at a right angle;
the plurality of indicators and the plurality of numeric characters being graphically distributed along a top surface of the blade;
the pencil holder being adjacently connected along an inner edge of the handle;
the lipped fence being adjacently connected along an outer edge of the handle, opposite of the pencil holder; and
the distance measuring unit being operatively coupled to the handle, wherein the distance measuring unit measure a perpendicular distance from the blade.

2. The square measuring tool as claimed in claim 1 comprises:
a fixed end of the handle being adjacently connected to a fixed end of the blade; and
a length of the outer edge being longer than a length of the inner edge.

3. The square measuring tool as claimed in claim 1 comprises:
each of the plurality of indicators being equally spaced apart from each other long the blade;
each of the plurality of numeric characters being equally spaced apart from each other long the blade; and
each of the plurality of numeric characters being adjacently aligned with a corresponding indicator from the plurality of indicators.

4. The square measuring tool as claimed in claim 1 comprises:
the pencil holder being extended from a fixed end of the handle to a free end of the handle; and
the pencil holder being positioned adjacent to a top surface of the handle.

5. The square measuring tool as claimed in claim 1 comprises:
the lipped fence being oriented perpendicular to the handle; and
the lipped fence being oppositely positioned to a top surface of the handle.

6. The square measuring tool as claimed in claim 1 comprises:
the distance measuring unit comprises at least one fastener and an electronic distance measuring device; and
the electronic distance measuring device being adjacently connected to a fixed end of the handle by the at least one fastener, wherein a rangefinder of the electronic distance measuring device is oriented towards the blade.

7. The square measuring tool as claimed in claim 1 comprises:
a mounting bracket;
a tape measure;
a tape guide;
the mounting bracket being terminally connected to the outer edge;
the mounting bracket being positioned adjacent to a free end of the handle;
the mounting bracket being oriented perpendicular to a top surface of the handle;
the tape guide being terminally connected to the lipped fence;
the tape guide being positioned adjacent to a fixed end of the handle; and
the tape measure being attached to the mounting bracket, wherein a flexible tape of the tape measure extends towards the blade.

8. A square measuring tool comprises:
a L-shaped body;
a pencil holder;
a lipped fence;
a distance measuring unit;
the L-shaped body comprises a handle, a blade, a plurality of indicators, and a plurality of numeric characters;
the handle and the blade being terminally connected to each other at a right angle;
the plurality of indicators and the plurality of numeric characters being graphically distributed along a top surface of the blade;
the pencil holder being adjacently connected along an inner edge of the handle;
the pencil holder being extended from a fixed end of the handle to a free end of the handle;
the pencil holder being positioned adjacent to a top surface of the handle;
the lipped fence being adjacently connected along an outer edge of the handle, opposite of the pencil holder; and
the distance measuring unit being operatively coupled to the handle, wherein the distance measuring unit measure a perpendicular distance from the blade.

9. The square measuring tool as claimed in claim 8 comprises:
the fixed end of the handle being adjacently connected to a fixed end of the blade; and
a length of the outer edge being longer than a length of the inner edge.

10. The square measuring tool as claimed in claim 8 comprises:
each of the plurality of indicators being equally spaced apart from each other long the blade;
each of the plurality of numeric characters being equally spaced apart from each other long the blade; and
each of the plurality of numeric characters being adjacently aligned with a corresponding indicator from the plurality of indicators.

11. The square measuring tool as claimed in claim 8 comprises:
the lipped fence being oriented perpendicular to the handle; and
the lipped fence being oppositely positioned to the top surface of the handle.

12. The square measuring tool as claimed in claim 8 comprises:
the distance measuring unit comprises at least one fastener and an electronic distance measuring device; and
the electronic distance measuring device being adjacently connected to the fixed end of the handle by the at least one fastener, wherein a rangefinder of the electronic distance measuring device is oriented towards the blade.

13. The square measuring tool as claimed in claim 8 comprises:
a mounting bracket;
a tape measure;
a tape guide;
the mounting bracket being terminally connected to the outer edge;
the mounting bracket being positioned adjacent to the free end of the handle;
the mounting bracket being oriented perpendicular to the top surface of the handle;
the tape guide being terminally connected to the lipped fence;
the tape guide being positioned adjacent to the fixed end of the handle; and
the tape measure being attached to the mounting bracket, wherein a flexible tape of the tape measure extends towards the blade.

14. A square measuring tool comprises:
a L-shaped body;
a pencil holder;
a lipped fence;
a distance measuring unit;
the L-shaped body comprises a handle, a blade, a plurality of indicators, and a plurality of numeric characters;
the handle and the blade being terminally connected to each other at a right angle;
a fixed end of the handle being adjacently connected to a fixed end of the blade;
a length of the outer edge being longer than a length of the inner edge;
the plurality of indicators and the plurality of numeric characters being graphically distributed along a top surface of the blade;
the pencil holder being adjacently connected along an inner edge of the handle;
the pencil holder being extended from the fixed end of the handle to a free end of the handle;
the pencil holder being positioned adjacent to a top surface of the handle;
the lipped fence being adjacently connected along an outer edge of the handle, opposite of the pencil holder; and
the distance measuring unit being operatively coupled to the handle, wherein the distance measuring unit measure a perpendicular distance from the blade.

15. The square measuring tool as claimed in claim 14 comprises:
each of the plurality of indicators being equally spaced apart from each other long the blade;
each of the plurality of numeric characters being equally spaced apart from each other long the blade; and
each of the plurality of numeric characters being adjacently aligned with a corresponding indicator from the plurality of indicators.

16. The square measuring tool as claimed in claim 14 comprises:
the lipped fence being oriented perpendicular to the handle; and
the lipped fence being oppositely positioned to the top surface of the handle.

17. The square measuring tool as claimed in claim 14 comprises:
the distance measuring unit comprises at least one fastener and an electronic distance measuring device; and
the electronic distance measuring device being adjacently connected to the fixed end of the handle by the at least one fastener, wherein a rangefinder of the electronic distance measuring device is oriented towards the blade.

18. The square measuring tool as claimed in claim 14 comprises:
a mounting bracket;
a tape measure;
a tape guide;
the mounting bracket being terminally connected to the outer edge;
the mounting bracket being positioned adjacent to the free end of the handle;
the mounting bracket being oriented perpendicular to the top surface of the handle;
the tape guide being terminally connected to the lipped fence;
the tape guide being positioned adjacent to the fixed end of the handle; and
the tape measure being attached to the mounting bracket, wherein a flexible tape of the tape measure extends towards the blade.
